(19) United States
(12) Patent Application Publication
(10) Pub. No.: US 2026/0078859 A1
(43) Pub. Date: Mar. 19, 2026

(54) VAPOR STOP MATERIAL FOR CRYOGENIC PIPES AND VESSELS

(71) Applicant: Owens Corning Intellectual Capital, LLC, Toledo, OH (US)

(72) Inventors: Helen Huang, Katy, TX (US); Helen Beyer Larsen, Granville, OH (US); William F. Sorsby, III, Millersport, OH (US); Steven R. Badger, Pittsburgh, PA (US)

(21) Appl. No.: 19/327,120

(22) Filed: Sep. 12, 2025

Related U.S. Application Data
(60) Provisional application No. 63/694,344, filed on Sep. 13, 2024.

(51) Int. Cl. F16L 59/02

(52) U.S. Cl. CPC F16L 59/028; F16L 59/029

(57) ABSTRACT

A cellular glass insulation system for an outer surface of a structure or pipe. The insulation system includes multiple segments of cellular glass. A lime coating having a reduced permeability is provided at the interface between the individual cellular glass segments and is configured to limit water intrusion.

### CROSS-REFERENCE TO RELATED APPLICATIONS

This application claims priority to and any benefit of U.S. Provisional Application No. 63/694,344, filed Sep. 13, 2024, the content of which is incorporated herein by reference in its entirety.

### FIELD

The present invention relates to insulation for cold-temperature parts, and more particularly, to systems and methods that avoid problems associated with intrusion of moisture and condensation of gases occurring between adjacent segments of insulation and the insulated area (e.g., a pipe).

### BACKGROUND

Cellular glass is a preferred choice for certain insulation applications due to its ability to maintain its shape under strenuous conditions and its closed-cell makeup, making it impermeable to water vapor and other condensed gases. Due to its rigid nature, cellular glass insulation is often fabricated into discrete sections for insulating pipes. While insulation materials perform the necessary purpose of energy conservation or process control, other problems may arise when using cellular glass insulation due to its closed cell nature as the joints between adjacent sections of insulation are susceptible to moisture intrusion. For instance, moisture can be trapped or otherwise allowed to migrate between the insulation and the surface of the pipe, causing potential damage to the system or reduction in performance.

Therefore, a need exists for an insulation system that can provide adequate insulation to structures including pipes and vessels in a variety of challenging environments, yet also prevent condensation of gases and corrosion along the interface between the insulation and the structure.

### SUMMARY

Piping and vessels operating at temperatures colder than −160° C. (e.g., down to −184° C.) pose unique challenges due to potential condensation of gases within and around the insulation system and at the interface between the insulation and insulated-part. The general inventive concepts utilize a vapor impermeable insulation (cellular glass) with a bore filler and vapor stop coating in the form of a cryogenic coating. This ensures a fully sealed system below-184° C. that inhibits the condensation of gases (ex. oxygen, water, nitrogen) within and around the system. By reducing the risk of condensation of the gases, the risk of fire is lessened and the general inventive concepts deliver an insulated system capable of stably running at or below-184° C. that is viable with traditional insulation methods (i.e. not a vacuum insulated piping system). This is an important development inasmuch as solutions for this range of temperatures regularly require systems that use vacuum to achieve the necessary temperature seal.

A common issue in systems operating below about −170° C. is the condensation of gases from the air that present both fire risks and thermal performance degradation, which ultimately destroy the insulation system. The general inventive concepts are based, in part, on the discovery that a fully sealed insulation system operating below −184° C. is required for a traditional mechanical insulation system to operate properly. If a bore filler vapor stop material is utilized between the first layer of insulation and the insulated part, a viable mechanical insulated system can be achieved in systems operating below −170° C. This is due, in part, to isolation of the extremely low temperatures within a first layer of insulation due to the gap-filling and sealing properties of the cryogenic coatings according to the general inventive concepts, when applied at terminations and within the inner interface between the part (e.g., a pipe) and the insulation.

In addition to good sealing and compatibility with cellular glass, a required property of a suitable vapor stop material is non-combustibility when in contact with flammable liquids (such as liquid oxygen). Vapor stop materials utilized in most mechanical insulation systems are composed of flammable organic materials. Whereas conventional inorganic coatings (also called cements) are permeable and may allow for unwanted gas and moisture infiltration between adjacent segments of pipe insulation as well as between the insulation and insulated part, especially at very low temperatures. The general inventive concepts seek to balance the impermeability (including at low temperatures) of organic sealants/bore fillers with the non-flammability of inorganic coatings (such as limes or gypsum).

In certain exemplary embodiments, the general inventive concepts contemplate a cryogenic coating in the form of an inorganic cement-like material comprising additives to reduce permeability of the coating. In certain embodiments, the cryogenic coating comprises a solid component and a liquid component. In certain embodiments, the solid component comprises a hydraulic lime, gypsum, or other inorganic material and the liquid component comprises a vapor reduction additive and water. In certain embodiments, the cryogenic coating comprises a vapor reduction additive in an amount of 5% to 50% by weight and the amount of water and vapor reduction additive together is from about 35% to about 150% by weight of the solid component.

In certain exemplary embodiments, the general inventive concepts contemplate a cellular glass insulation system. The system comprises a plurality of cellular glass insulation segments positioned in a layer around an exterior of a part to be insulated and a cryogenic coating, wherein the cellular glass insulation segments have a length, an inner bore, side joint sections extending the length of the cellular glass insulation segment between the inner bore and an exterior of the cellular glass insulation segment, a thickness in a radial direction, and a termination; and wherein the cryogenic coating is positioned in the interface between the part and the insulation layer and covering an interface between the termination and the exterior of the pipe or on the interface between the insulation layer and insulated part.

In certain exemplary embodiments, the general inventive concepts contemplate a method of insulating a pipe or vessel. The method comprises providing a plurality of cellular glass insulation segments and a cryogenic coating; the cellular glass insulation segments comprising a length, an inner bore, side joint sections extending the length of the cellular glass insulation segment between the inner bore and an exterior of the cellular glass insulation segment, a thickness in a radial direction, and a termination; positioning the plurality of cellular glass insulation segments around the exterior of the pipe to form a first layer of cellular glass insulation; and applying the cryogenic coating to the interface between the pipe and the inner bore of the first layer of cellular glass insulation segments and on the termination of the first layer of cellular glass insulation and along an interface formed between the inner bore and the exterior of the pipe or vessel.

Other aspects and features of the general inventive concepts will become more readily apparent to those of ordinary skill in the art upon review of the following description of various exemplary embodiments in conjunction with the accompanying figures.

### BRIEF DESCRIPTION OF THE DRAWINGS

The general inventive concepts, as well as embodiments and advantages thereof, are described below in greater detail, by way of example, with reference to the drawings in which:

FIG. 1 is a perspective view of a conventional cellular glass insulation positioned around a pipe.

FIG. 2 is a front view of a conventional cellular glass insulation positioned around a pipe.

FIG. 3 shows a cellular glass insulation system positioned around a pipe, showing a coating applied at terminations and interfaces of the insulation system.

FIG. 4 is an image of an exemplary cellular glass insulation system according to the general inventive concepts.

FIG. 5 is an image of another exemplary cellular glass insulation system according to the general inventive concepts.

FIG. 6 is an image of a coated pipe section and cellular glass termination.

FIG. 7 is an image of a coated cellular glass segment, the coating is comprised of lime 3.5 and water, with no additive.

FIG. 8 is an image of a coated cellular glass segment, the coating is comprised of lime 3.5 and water, with a wax additive according to the general inventive concepts.

FIG. 9 is an image of a coated cellular glass segment, the coating is comprised of lime 5 and water, with no additive.

FIG. 10 is an image of a coated cellular glass segment, the coating is comprised of lime 5 and water, with a wax additive according to the general inventive concepts.

FIG. 11 is an image of a coated cellular glass segment, the coating is comprised of gypsum and water, with no additive.

FIG. 12 is an image of a coated cellular glass segment, the coating is comprised of gypsum and water, with a wax additive according to the general inventive concepts.

### DETAILED DESCRIPTION

Several illustrative embodiments will be described in detail with the understanding that the present disclosure merely exemplifies the general inventive concepts. Embodiments encompassing the general inventive concepts may take various forms and the general inventive concepts are not intended to be limited to the specific embodiments described herein.

While various exemplary embodiments are described or suggested herein, other exemplary embodiments utilizing a variety of methods and materials similar or equivalent to those described or suggested herein are encompassed by the general inventive concepts.

Unless defined otherwise, all technical and scientific terms used herein have the same meaning as commonly understood by one of ordinary skill in the art to which the invention belongs. In this connection, unless otherwise indicated, concentrations of ingredients given in this document refer to the concentrations of these ingredients in the master batch or concentrate, in keeping with customary practice.

The term “solid component” as used herein refers to inorganic dry ingredients such as a gypsum base (e.g., Hydrocal B11) or a lime, which form a thick paste when mixed with water and which set by hydration (i.e., addition of water). Natural hydraulic lime is known to react with both water (through hydraulic set) and carbon dioxide in the air (through carbonation). Examples of hydraulic lime include lime 2 (which generally includes up to 10% clay by weight), lime 3.5 (which generally includes from 11% to 20% clay by weight), and lime 5 (which generally includes from 21% to 30% clay by weight). Natural hydraulic lime (NHL) is produced by heating (calcining) limestone that naturally contains clay and other impurities. Gypsum and limes such as hydraulic lime are contrasted with materials such as cement in that they do not include sand or fillers. The solid component may comprise a gypsum base, a lime, or a combination thereof.

The term “coating mixture” as used herein refers to the combination of a solid component (e.g., gypsum or a lime) and a liquid component (e.g., water, or water and a vapor reduction additive) to form a settable mixture.

The term “cryogenic coating” as used herein, refers to a coating mixture wherein a vapor reduction additive has displaced a portion of the water in the coating mixture. For example, a hydraulic lime, lime, gypsum, or combinations thereof, mixed with water, and a vapor reduction additive, according to the general inventive concepts. In certain embodiments, the solid component and the liquid component are combined in a ratio of about 2:5 to about 3:2 by weight.

The term “vapor reduction additive” as used herein, refers to a chemical composition that, when incorporated into a mixture to form a cryogenic coating prior to setting, reduces the vapor permeability and permeance of the mixture. In certain embodiments, the vapor reduction additive is an emulsion that displaces a portion of the water that would otherwise make up the liquid portion of a conventional coating mixture. In certain embodiments, the inclusion of the vapor reduction additive results in the amount of water being less than what would otherwise be necessary for suitable curing/setting of the coating mixture.

The term “displacing a portion of the water” as used herein, refers to a modification of the ingredient formula to make a cryogenic coating. The modification entails replacing a portion of the water (or otherwise liquid portion) that would conventionally be used to make a coating mixture with an amount of a vapor reduction additive. Thus, in certain exemplary embodiments, the total amount of water and vapor reduction additive is about 200% to about 150% by weight based on the solid component. The total amount of liquid may not directly correspond to the original amount of water. For example, in a typical mixing procedure: a solid component, 100 g lime base (e.g., hydraulic lime), is mixed with a liquid component, 50 g of water. Whereas a mixing procedure for a cryogenic coating comprises 100 g hydraulic lime+20 g of vapor reduction additive (e.g., hydrocarbon wax emulsion or silicone emulsion))+17 g of water are mixed to form a cryogenic coating. In another embodiment, 100 g of lime 5.0, 44 g of vapor reduction additive (e.g., hydrocarbon wax), and 25 g water are mixed to form a cryogenic lime coating. In certain exemplary embodiments, the total amount of vapor reduction additive is between about 5% and 50% by weight of the solid component.

The term “hyper-cryogenic” as used herein, refers to a temperature range that is substantially below ambient and includes temperatures below the normally accepted threshold for cryogenic temperatures and for use with the storage or transportation of certain materials e.g., liquid nitrogen, liquid oxygen, liquid hydrogen, up to liquid helium, among others. The temperature range is substantially below ambient and includes temperatures below about −165° C., including from below about −165° C. to about −253° C., including below about −190° C., including below about −205° C., including below about −219° C., including below about −227° C., including below about −236° C., including below about −241° C., including below about −247° C., and including below about −250° C.

The term “termination” as used herein refers to an end of a cellular glass insulation segment or run of cellular glass insulation segments. The termination is characterized by the end of cellular glass insulation segment that does not abut an adjoining insulation segment. Terminations are often a feature of pipe insulation provided at junctions or elbows as the rigid nature of cellular glass cannot accommodate for the change in pipe structure.

The term “vapor stop” refers to a material that is positioned or applied to a termination or joint between adjacent/adjoining segments of insulation (i.e., between butt-joints or between layers of insulation in a multi-layer insulation system and between the first layer of insulation and the pipe-“bore filler”) to prevent ingress or movement of undesired vapor, including water vapor due to condensation at cryogenic or hyper-cryogenic temperatures. As used herein, the term generally refers to a cryogenic coating that is positioned at terminations or in joints or that which is applied in a wet form at the interface between an inner layer of insulation and the exterior of a part (e.g., a pipe) to fill the gap between the two (i.e., a bore-filler).

In certain exemplary embodiments, the general inventive concepts contemplate a coated insulation product for use with a pipe or vessel operating at cryogenic/hyper-cryogenic temperatures. The cryogenic coating composition is applied to at least one “joint” of a cellular glass pipe insulation product to form a barrier to prevent moisture intrusion at below cryogenic to hyper-cryogenic temperatures (i.e., below −165° C.). There are several important considerations that must be taken into account when insulating a part (e.g., a pipe) that stores or transports liquids at very low temperatures (e.g., liquid nitrogen, liquid hydrogen, or liquid oxygen at hyper-cryogenic temperatures). Due to the very low temperatures involved, water vapor is much more likely to penetrate gaps in sealing the system and oxygen can condense around weak points in the insulation leading to the presence of combustible liquid oxygen around the system. The intrusion of moisture into an insulation system can cause significant complications to an industrial facility or its owner. In particular, the ingress of water can reduce insulative capacity and cause costly repairs or downtime. The condensation of oxygen from the ambient air can increase risk of fire. Further, the system, including sealants and coatings must have a very low (i.e., less than 5%) organic content for liquid oxygen compatibility. This poses issues as many sealants or coatings that would otherwise be used at these temperatures have an organic content above this 5% safety threshold.

One key feature of the general inventive concepts is the full sealing of the insulation in a continuous layer which covers the condensation temperature of problematic gases. This is accomplished with a modified inorganic coating material (i.e., a cryogenic coating) that has a low to very low permeability. In this manner the mechanical insulation system is fully sealed at temperatures colder than the condensation temperature of the gas of concern.

In the case of cellular glass, due to its property of being vapor impermeable, the damage due to vapor intrusion is the result of moisture (vapor) penetrating the spaces at the termination or between layers of the cellular glass insulation. To avoid degraded thermal characteristics from the intrusion of water vapor, an effective insulation system needs to prevent the intrusion of water into the system. If water does infiltrate the sealed system (due to damage or other circumstances) the insulation system still needs to be able to contain/isolate the moisture ingress to prevent progressive damage. However, many conventional systems that pass the organic content safety threshold suffer from unacceptable vapor permeability. The general inventive concepts seek to address each of these drawbacks by way of a cryogenic coating according to the general inventive concepts.

Cellular glass is a rigid, non-porous insulation material. One use for cellular glass is insulation of pipes, including those in cryogenic or hyper-cryogenic applications. Because cellular glass is not flexible, in order to form customized insulation products, cellular glass must be formed or otherwise shaped into fabricated sections (e.g., half sections, quarter sections, or segments) that fit around the exterior of the pipe being insulated. The cellular glass pipe insulation is typically fabricated using a cement to seal discrete cellular glass sections together. There are a variety of conventional cements used in these applications. However, these conventional cements are often porous, leading to water vapor infiltration, especially in low or very low temperature uses.

While not wishing to be bound by theory, the inventors believe the porosity of unmodified gypsum or lime mixtures (i.e., those that include only a solid component and water), which is known to have an unsatisfactory vapor permeability for use in cold part insulation, can be decreased by occlusion of the pores of the unmodified coating mixture. Therefore, the general inventive concepts contemplate a new cryogenic coating composition for sealing insulation systems and a method of reducing the permeability of a conventional coating. The new formulation comprises a solid component (e.g., a hydraulic lime) combined with water and a vapor reduction additive that displaces a portion of the water that would otherwise make up the conventional coating mixture. Particular embodiments of the vapor reduction additive include a hydrocarbon wax emulsion, a silicone-containing additive/emulsion, and combinations thereof.

The general inventive concepts contemplate coatings that are used in systems that require low organic content, excellent vaper permeability resistance, and compatibility with cellular glass insulation. In certain exemplary embodiments, the cryogenic coatings comprise a solid component and a liquid component, wherein the liquid component comprises a vapor reduction additive as described herein. In certain exemplary embodiments, the vapor reduction additive is a hydrocarbon wax emulsion made up of approximately 50% wax, with the remainder water. Suitable wax emulsions include, but are not limited to Hydrocer DP69 paraffin wax emulsion sold by Shamrock Technologies. In certain exemplary embodiments, the vapor reduction additive is a silicone emulsion made up of approximately 50%-65% of a silicone ingredient (i.e., dimethyl polysiloxane), with the remainder water. Suitable silicone emulsions include, but are not limited to ICM346 and ICM1643 (also sold as Variphob CC1643) sold by ICM Products Inc.,

The method of the general inventive concepts involves replacing a portion of the water used to mix/activate the solid component with a volume of the vapor reduction additive (e.g., a wax emulsion) to form a cryogenic coating. The coating is then applied to the cellular glass at one or more of an inner interface between cellular glass and a part to be insulated, terminations of the insulation, and surrounding surfaces. In certain embodiments, the coating is applied at a thickness of greater than 0.5 mm, including a thickness of about 0.5 mm to about 4 mm, including a thickness of about 0.5 mm to about 3.7 mm, including a thickness of about 0.5 mm to about 3.3 mm, including a thickness of about 0.5 mm to about 3 mm, including a thickness of about 0.5 m to about 2.8 mm, including a thickness of about 0.5 mm to about 2.4 mm, including a thickness of about 0.5 mm to about 2 mm, including a thickness of about 0.5 mm to about 1.6 mm, including a thickness of about 0.5 mm to about 1.4 mm, including a thickness of about 0.5 mm to about 1 mm, including a thickness of about 0.7 mm to about 4 mm, including a thickness of about 0.9 mm to about 4 mm, including a thickness of about 1 mm to about 4 mm, including a thickness of about 1.3 mm to about 4 mm, including a thickness of about 1.5 mm to about 4 mm, including a thickness of about 1.9 mm to about 4 mm, including a thickness of about 2.2 mm to about 4 mm, including a thickness of about 2.5 mm to about 4 mm, and including a thickness of about 3 mm. Larger thicknesses (e.g., those approaching 3-4 mm) are suitable for bore filler type application wherein the coating is applied wet to either the exterior of the part/pipe or to the interior portion/surface of the cellular glass and the two are brough together and compressive force is applied (e.g., to ensure good seal and filling of the newly formed space). One important property for the bore-filler applications is removing space at annulus for vapors to accumulate/travel in the system.

In certain embodiments, the cryogenic coating is characterized by a water vapor transmission rate according to ASTM E96 (after setting) of less than 0.03 perm-inch, including less than 0.02 perm-inch, including less than 0.019 perm-inch, including less than 0.018 perm-inch, including less than 0.017 perm-inch.

While the general inventive concepts are applicable to a variety of insulation systems, the cellular glass for use according to the general inventive concepts is characterized by a low water vapor permeability. This in conjunction with the inventive cryogenic coating's ability to adhere to and seal the joints in the cellular glass insulation system through temperature cycles that include hyper-cryogenic temperatures (e.g., −165° C. to −253° C.) provides an improved cellular glass insulation system.

In certain exemplary embodiments, the vapor reduction additive is present in the cryogenic coating in an amount of less than 50% by weight based on the weight of the solid component, including 5% to 50% by weight, including 10% to 45% by weight, including 15% to 41% by weight, including 20% to 37% by weight, including 20% to 30% by weight, including 20% to 28% by weight, including 22% to 50% by weight, including 25% to 50% by weight, including 27% to 50% by weight, and including about 21% to about 27% by weight.

In certain exemplary embodiments, the amount of water and vapor reduction additive together is from about 35% to about 150% by weight of the solid component (i.e., the gypsum base or lime solids).

In certain embodiments, the cryogenic coating may further comprise optional ingredients based on the needs of the particular insulation system. In certain embodiments the cryogenic lime coating comprises a fibrous reinforcement. The fibrous reinforcement may take the form of short fibers that are mixed into the coating mixture prior to application and setting. In certain embodiments, the fibrous reinforcement is present in the cryogenic lime coating in an amount of 0.5% to 2% by weight, including 0.5% to 1.7%, including 0.5% to 1.2%, including 0.5% to 0.9%, including 0.7% to 2%, including 0.85% to 2%, and including about 0.88% by weight. In certain embodiments, the cryogenic coating may optionally comprise a colorant. In certain embodiments, the colorant is present to provide the coating with an aesthetic that more closely resembles that of cellular glass. In certain embodiments, the cryogenic coating comprises a black colorant.

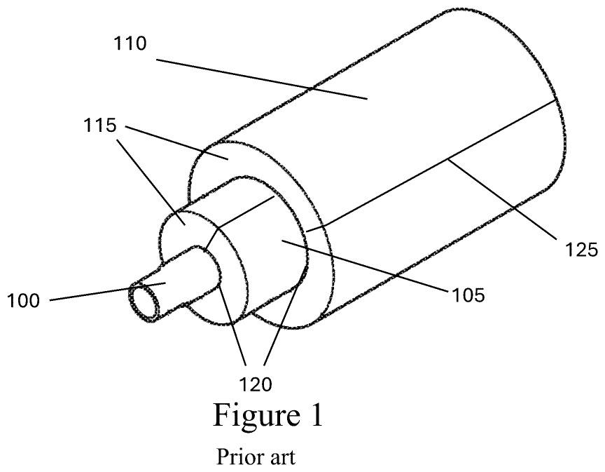

FIG. 1 shows a conventional pipe insulation system comprising two layers of cellular glass and showing a termination or end of the cellular glass insulation. In some embodiments, the part/pipe 100 is insulated with two layers of cellular glass. The first annular layer 105 is positioned about the pipe and the second, larger annular layer 110 is positioned around and substantially surrounding the first layer of cellular glass insulation. Those of ordinary skill in the art will recognize that for very low temperature insulation, other layers of insulation and jacketing will be required, but in the interests of conciseness the discussion herein will be focused on the cellular glass and cryogenic coating portions of the system. In the embodiments shown, each of the first inner layer and the second outer layer are made from ½ sections of cellular glass that meet at side joints 125 extending the length of the individual cellular glass segments. These ½ sections are brought together, with the first inner layer around the and the outer layer being positioned on the inner layer after it is installed around the pipe to form the insulation. Each of the first annular layer of cellular glass and the second annular layer of cellular glass ends in a termination 115. There is a gap or seam 120 formed at the interface between the pipe and the first annular layer of cellular glass and another second seam between the first, inner layer of cellular glass and the second, outer layer of cellular glass. Each of these joints/scams are potentially vulnerable to vapor intrusion at cryogenic temperature. As previously mentioned, terminations are a feature of cellular glass insulation that are often required to accommodate features of piping such as flanges and elbows of the pipe.

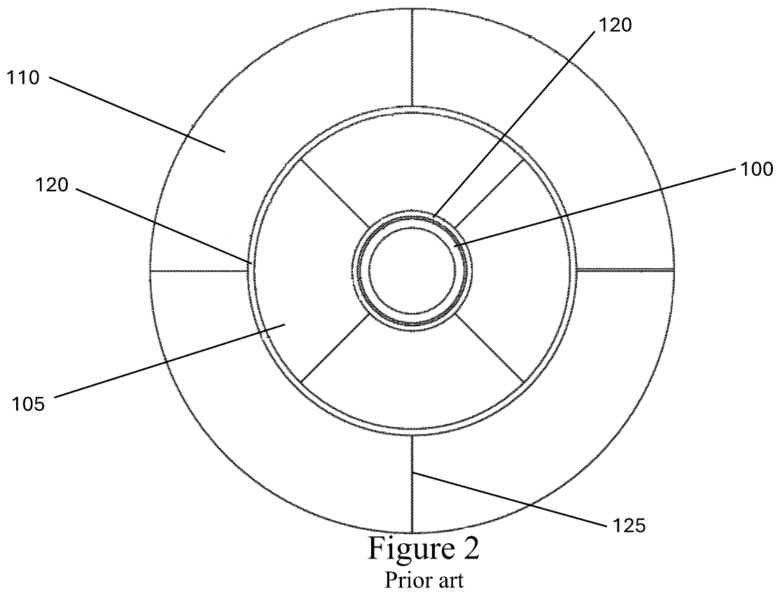

FIG. 2 shows an insulated pipe with two layers (i.e., an inner layer 105 positioned on and around the pipe and a larger, outer layer 110 positioned around the inner layer) of cellular glass insulation insulating the pipe 100. In this embodiment, each layer of cellular glass insulation is made up of four ¼ segments of cellular glass that meet at side joints 125. At the interface between the inner bore of the inner layer 105 and the exterior of the pipe 100, is a gap or seam 120. A similar gap or seam 120 is also present at the interface between the inner bore of the outer layer 110 and the exterior of the inner layer 105 (and so on and so forth depending on the number of layers of insulation). These seams provide a potential point of vapor intrusion during operation of the pipe. The general inventive concepts provide system comprising a plurality of cellular glass segments (including in certain embodiments, multiple layers of cellular glass insulation) and a cryogenic coating that, when installed together, reduce or prevent moisture or vapor intrusion and reduce the drawbacks of conventional cold-temperature pipe insulation systems.

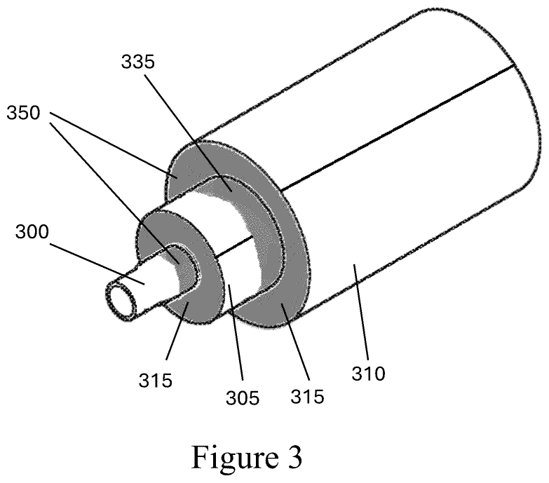

FIG. 3 is a perspective view of a cellular glass pipe insulation system according to the general inventive concepts. The system comprises at least two layers of cellular glass insulation positioned around an exterior of the part/pipe and a cryogenic coating applied e.g., at a termination. In the figure, two layers of cellular glass are shown, but those of ordinary skill will understand that the concepts described herein are applicable to system comprising greater numbers of layers, e.g., three layers of cellular glass, or more. As can be seen from the figure, the coating 350 (shown with dark gray shading) is applied at the interface or seam (i.e., covering the seam) between the pipe 300 and an inner bore (also called the inner pipe bore when referring to the innermost layer of cellular glass insulation) of the inner layer 305 of cellular glass insulation and on the termination 315 of the inner layer. Likewise, in certain embodiments, the cryogenic coating according to the general inventive concepts is applied on the termination 315 of the second, outer layer 310 of cellular glass insulation to cover/seal the seam created at the interface between the inner layer of cellular glass and the outer layer of cellular glass. The cryogenic coating is shown as applied to the entire termination side of the cellular glass insulation layers. Those of ordinary skill in the art will recognize that the cryogenic coating may be applied across the total thickness of the termination side or on only a portion of the total thickness. In general, the cryogenic coating will be applied across a portion of the circumference of the cellular glass layer, including up to the entire circumference of the thickness of the cellular glass insulation layer or seam. Similarly, the cryogenic coating is shown as being applied to a portion of the pipe length and to a portion of the exterior surface 335 of the inner insulation layer pipe (in certain embodiments, a thicker layer of cryogenic coating is applied wet as a bore-filler around the part/pipe prior to installation of the cellular glass). Those of ordinary skill will understand that the exact coverage area or length may vary depending on the particular needs of the insulation system, so long as the seam is coated/sealed across substantially the whole circumference of the interface between either the pipe and the inner layer of cellular glass insulation layer and/or the inner layer and an adjoining outer layer of cellular glass insulation. Likewise, while the cryogenic coating has not been shown on the exterior surface of the outer later, the general inventive concepts recognize that the needs of the particular system may require application of the coating to an exterior of an outermost layer to achieve proper system sealing, thereby those forms may also fall within the general inventive concepts.

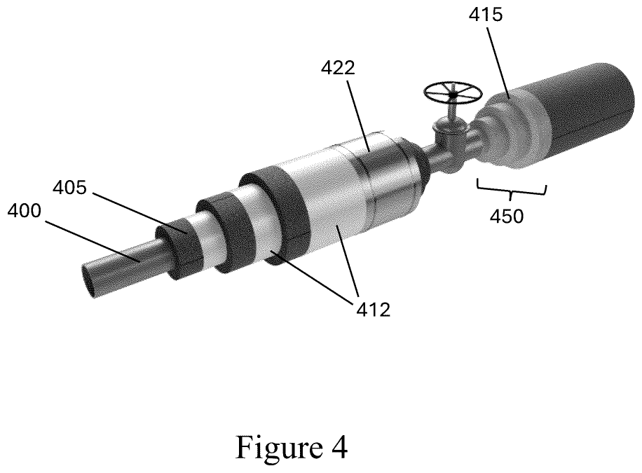

FIG. 4 shows an exemplary pipe 400 and cellular glass insulation system installed thereon. In this embodiment, the insulation system includes three layers of cellular glass, 405 (the general inventive concepts contemplate multiple layer of cellular glass, each having a thickness in the radial direction of 1-4 inches, including about 2 inches per layer), the system also includes optional vapor barrier jacketing 412 between each layer of cellular glass and exterior jacketing. The termination 415 of the cellular glass layers are shown with a cryogenic coating 450 according to the general inventive concepts applied as a substantially contiguous layer from the pipe surface across each interface and termination face of the cellular glass and to the outer surface of the exterior-most layer of cellular glass insulation.

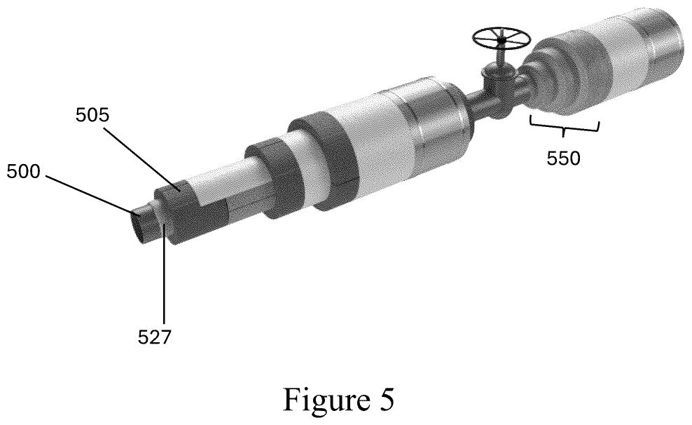

FIG. 5 shows a similar pipe 500 and cellular glass insulation system as that shown in FIG. 4. The figure shows three layers of cellular glass, vapor barriers, jacketing, and a cryogenic coating 550 applied from the pipe surface and across the seams and terminations of the system, out to the exterior surface of the outermost cellular glass layer. FIG. 5 further includes a layer of a cryogenic coating 527 applied within the pipe bore between the outer surface of the pipe and the inner surface of the bore of the innermost layer of cellular glass (i.e., it serves as a gap/bore-filler).

The general inventive concepts contemplate a method of insulating a pipe at cryogenic temperatures. The method comprises providing a plurality of cellular glass insulation segments and a cryogenic coating. The cellular glass insulation segments comprising a length, an inner bore, and side joint sections extending the length of the cellular glass insulation segment between the inner bore and an exterior of the cellular glass insulation segment. The plurality of cellular glass insulation segments are positioned around the pipe (e.g., encircling the circumference of the pipe exterior) to form a first layer of cellular glass insulation. In certain embodiments, a cryogenic coating is applied in a wet form to either or both of the inner pipe bore of the insulation segments or to the exterior of the pipe (i.e., forms an annular coating around the exterior of the pipe). The insulation is then positioned on the pipe. In certain embodiments, the cryogenic coating is applied in a sufficient amount to fill or completely fill the space formed between the pipe and the inner pipe bore. In certain embodiments, the cryogenic coating is applied in an amount such that it is squeezed out from the joint sections during installation. The cryogenic coating is likewise applied to the termination of the cellular glass insulation and along an interface formed between the inner bore and the exterior of the pipe. In certain exemplary embodiments, the method further comprises positioning a second layer of cellular glass insulation around the first layer of cellular glass insulation (e.g., encircling the circumference of the pipe exterior) to form a second layer of cellular glass insulation, and applying the cryogenic coating to the termination of the second layer of cellular glass insulation and along an interface formed between the inner bore of the second layer of cellular glass insulation and the exterior surface of the inner layer of cellular glass insulation. In certain exemplary embodiments, the coating is applied to a portion of the circumference of the interface/seam up to and including the entire circumference. This may then be repeated for additional layers of cellular glass insulation up to the required number (e.g., 3 or more layers).

The method of application of the coating is not necessarily limited so long as the cryogenic coating is applied to the system in a manner suitable to achieve the desired durability and vapor (im)permeability at operational (i.e., hyper-cryogenic) temperatures. In certain exemplary embodiments, the cryogenic coating is applied by way of brushing, spraying, coating, troweling, etc.

### Examples

The following examples illustrate features and/or advantages of the systems and methods according to the general inventive concepts. The examples are given solely for the purpose of illustration and are not to be construed as limitations of the general inventive concepts, as many variations thereof are possible without departing from the spirit and scope of the general inventive concepts.

In one embodiment, a cryogenic coating is formulated comprising 1800 g natural hydraulic lime (e.g., lime 5.0); 775 g of a hydrocarbon wax emulsion (e.g., about 50% water and 50% wax), 495 g of water, 28 g of a fibrous reinforcement (e.g., Anti-Crak HD); and optionally 20 g of a black colorant (e.g., Astro Black).

In certain exemplary embodiments, the cryogenic coating has a water vapor transmission rate of less than 0.017 perm-inch according to ASTM E96 water vapor permeability test dry cup, with 21% by weight of vapor reduction additive (e.g., wax emulsion). In certain embodiments, the cryogenic lime coating has a water vapor transmission rate of about zero, with 27% of vapor reduction additive (e.g., wax or silicone emulsion).

A series of cryogenic coatings (lime mixtures) were formulated using either lime 3.5 or lime 5.0 in an amount of 50 g with 21.7% by weight of a hydrocarbon wax emulsion and the remainder made up of water. The samples were tested according to ASTM E96 and were subjected to 50% relative humidity at 25° C. over a period of 800 hours. The measured weight gain over time was determined and show essentially no weight gain, demonstrating that lime coatings according to the general inventive concepts demonstrate surprising vapor resistance (i.e., very low to no vapor permeability). The measured weight loss over time was similarly determined and also showed very good water vapor resistance (i.e., very low permeability).

A series of cryogenic coatings (gypsum mixtures) were formulated using gypsum, 20% water by weight of gypsum (Hydrocal B11), and a series of vapor reduction additives (silicones) including ICM346 (20% per gypsum weight), ICM643 (20% per gypsum weight), DP69 (20% per gypsum weight), and a control with no additive. The measured weight gain over time was determined and the water vapor permeability (perm-inch) for the samples was determined and are as follows: ICM346: 0.017 perm-inch, ICM643 0.006 perm-inch, DP69 0.001 perm-inch, and the control sample had a value of 0.214 perm-inch. This demonstrates that cryogenic coatings according to the general inventive concepts demonstrate surprising vapor resistance (i.e., very low to no vapor permeability).

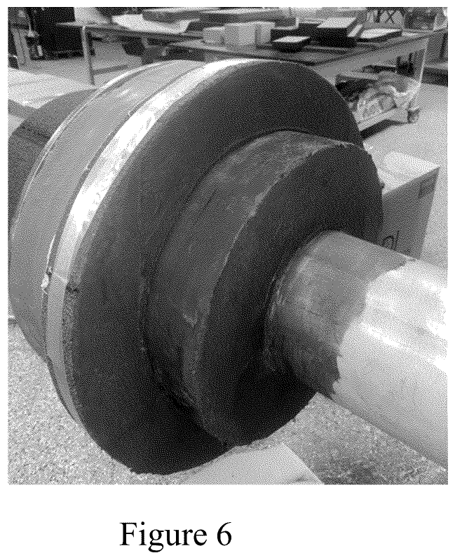

A liquid-containing pipe with multiple layers of cellular glass insulation was coated with a lime coating according to the general inventive concepts along a portion of the pipe surface and at terminations. FIG. 6 shows a picture of the insulation system and cryogenic (lime) coating at a termination. The pipe/system cooled to −100° C. and held overnight. The system was then cooled further to a temperature of −165° C. and held overnight. On day 3 the pipe was filled with liquid nitrogen at −196° C. for several hours and was allowed to warm overnight. The pipe warmed to a temperature of −135° C. on day 4 and was filled with liquid nitrogen again to −196° C. On day 5 the system was allowed to warm. The system showed no evidence of the coating breaking after the cryogenic cycles and there was no damage to the vapor stop or to the surrounding cellular glass.

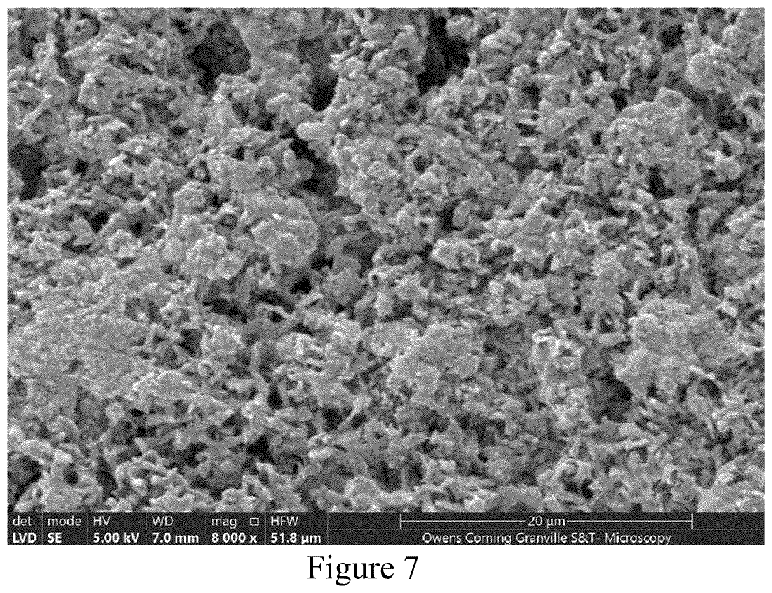

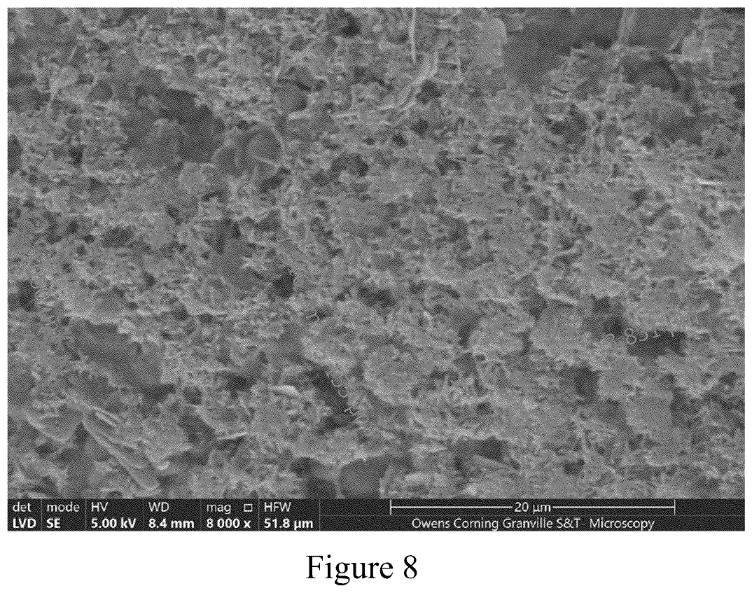

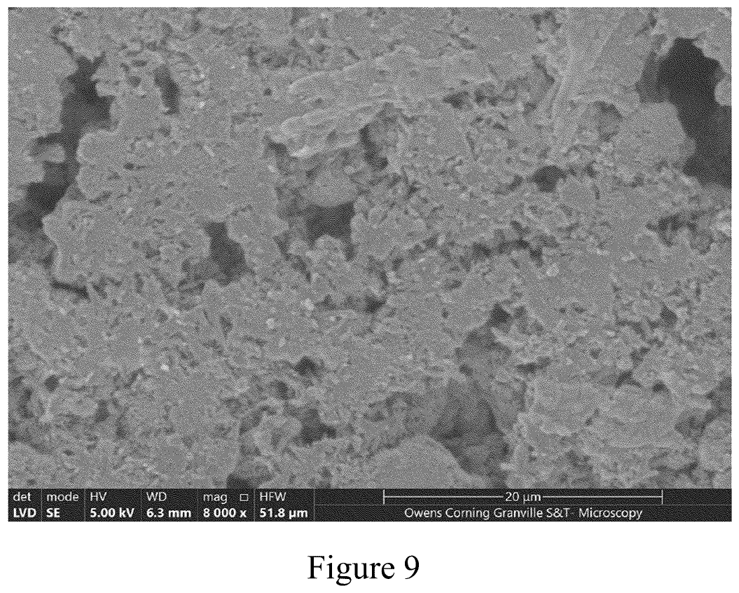

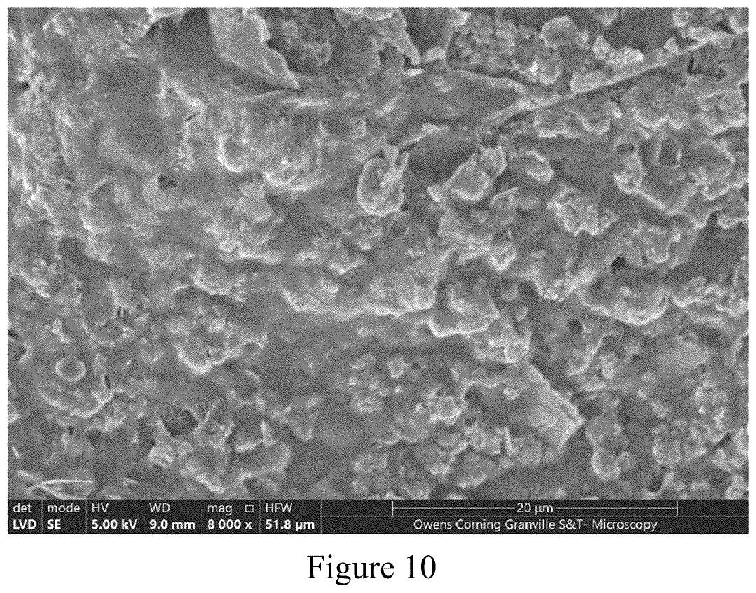

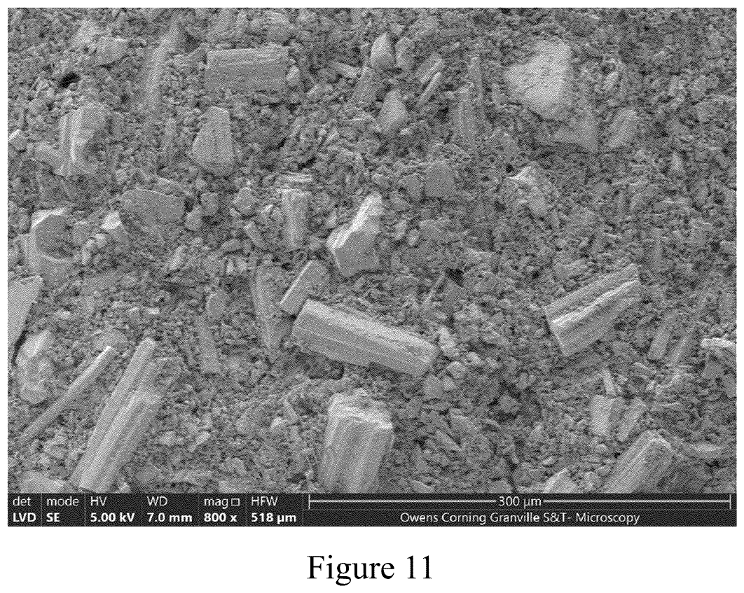

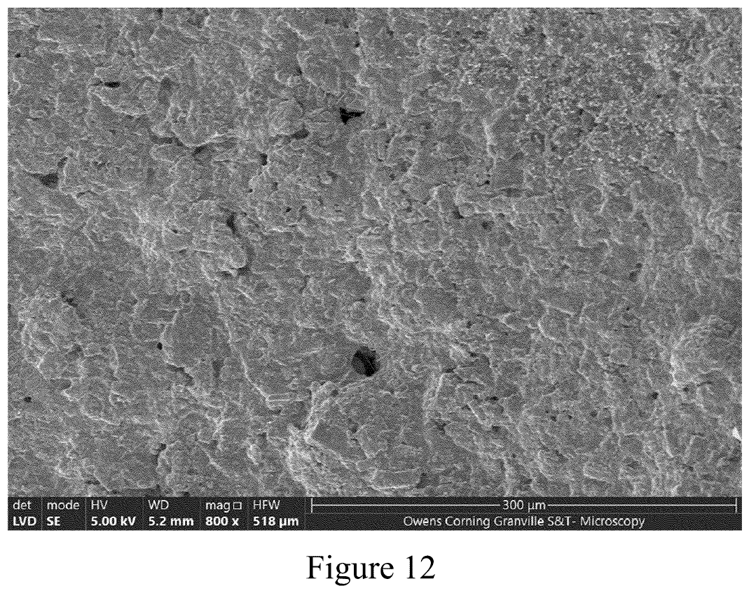

A series of coatings were made and applied onto cellular glass segments and allowed to dry/cure. The samples were then imaged under a SEM microscope to determine the average pore/void size. SEM images showing the respective coated cellular glass samples are shown sequentially in FIGS. 7-12. The samples were made according to recipes shown in Table 1.

TABLE 1

| | | | | Pore | |
|---|---|---|---|---|---|
| | Solid | | Vapor | size | |
| | Component | Water | reduction | range | Average |
| Sample | (g) | (g) | Additive | (μm) | (μm) |
| 1 | Lime 3.5-5 g | 4 g | N/A | 1-10 | 5 |
| 2 | Lime 3.5-5 g | 2 g | DP69 - 1.8 g | 1-3 | 1.5 |
| 3 | Lime 5.0-5 g | 3 g | N/A | 3-13 | 7 |
| 4 | Lime 5.0-5 g | 1.1 g | DP69 - 1.8 g | 1-3 | 1.5 |
| 5 | Gypsum - 10 g | 3.3 g | N/A | 5-15 | 8 (largest up |
| | | | | | to 100 μm) |
| 6 | Gypsum - 10 g | 1 g | DP69 - 1 g | 2-4 | 3 (largest up |
| | | | | | to 100 μm) |

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more (e.g., 1 to 6.1), and ending with a maximum value of 10 or less (e.g., 2.3 to 9.4, 3 to 8, 4 to 7), and finally to each number 1, 2, 3, 4, 5, 6, 7, 8, 9, and 10 contained within the range.

The cellular glass compositions, and corresponding methods of the present disclosure can comprise, consist of, or consist essentially of the essential elements and limitations of the disclosure as described herein, as well as any additional or optional ingredients, components, or limitations described herein or otherwise useful in cellular glass composition applications.

The cellular glass compositions of the present disclosure may also be substantially free of any optional or selected ingredient or feature described herein, provided that the remaining composition still contains all of the required elements or features as described herein. In this context, and unless otherwise specified, the term “substantially free” means that the selected composition contains less than a functional amount of the optional ingredient, typically less than 0.1% by weight, and also including zero percent by weight of such optional or selected essential ingredient.

To the extent that the terms “include,” “includes,” or “including” are used in the specification or the claims, they are intended to be inclusive in a manner similar to the term “comprising” as that term is interpreted when employed as a transitional word in a claim. Furthermore, to the extent that the term “or” is employed (e.g., A or B), it is intended to mean “A or B or both A and B.” When the Applicant intends to indicate “only A or B but not both,” then the term “only A or B but not both” will be employed. Thus, use of the term “or” herein is the inclusive, and not the exclusive use. In the present disclosure, the words “a” or “an” are to be taken to include both the singular and the plural. Conversely, any reference to plural items shall, where appropriate, include the singular.

In some embodiments, it may be possible to utilize the various inventive concepts in combination with one another. Additionally, any particular element recited as relating to a particularly disclosed embodiment should be interpreted as available for use with all disclosed embodiments, unless incorporation of the particular element would be contradictory to the express terms of the embodiment. Additional advantages and modifications will be readily apparent to those skilled in the art. Therefore, the disclosure, in its broader aspects, is not limited to the specific details presented therein, the representative apparatus, or the illustrative examples shown and described. Accordingly, departures may be made from such details without departing from the spirit or scope of the general inventive concepts.

While the invention has been illustrated and described in detail in the drawings and foregoing description, the same is to be considered as illustrative and not restrictive in character. It should be understood that only the exemplary embodiments have been shown and described and that all changes and modifications that come within the spirit of the invention are desired to be protected.

1. A cryogenic coating comprising a solid component, a vapor reduction additive, and water, wherein the coating comprises the vapor reduction additive in an amount of 5% to 50% by weight and the amount of water and vapor reduction additive together is from about 70% to about 150% by weight of the solid component.

2. The cryogenic lime coating of claim 1, wherein the coating has a water vapor permeance of less than about 0.02 after setting.

3. The cryogenic lime coating of claim 1 wherein the vapor reduction additive is selected from a hydrocarbon wax emulsion and a silicone emulsion.

4. A cellular glass insulation system comprising:
a plurality of cellular glass insulation segments positioned in a layer around an exterior of a part; and
a cryogenic coating,
wherein the cellular glass insulation segments have a length, an inner surface, a pair of opposed side joint sections extending the length of the cellular glass insulation segment between the inner bore and an exterior of the cellular glass insulation segment, a thickness in a radial direction, and a termination;
wherein the cryogenic coating is positioned on the termination and covering an interface between the termination and the exterior of the part.

5. The cellular glass insulation system of claim 4, wherein the system comprises a first layer of cellular glass insulation segments positioned on the part and a second layer of cellular glass insulation segments positioned on an exterior of the first layer of cellular glass insulation segments.

6. The cellular glass insulation system of claim 5, wherein the cryogenic coating is applied to cover an interface between the inner cellular glass insulation layer and the outer cellular glass insulation layer.

7. The cellular glass insulation system of claim 4, wherein the part is a pipe and the cryogenic coating is applied to cover the seam on a circumference of the pipe.

8. The cellular glass insulation system of claim 7, wherein the cryogenic coating is applied directly to the pipe and to cover the interface on an entire circumference of the inner layer of cellular glass.

9. The cellular glass insulation system of claim 4, wherein the cryogenic coating is applied to cover the entire thickness of the termination.

10. The cellular glass insulation system of claim 4, wherein the cryogenic coating is applied to a thickness of about 0.5 mm to about 4 mm.

11. The cellular glass insulation system of claim 4, wherein the pipe operates at a temperature range of below about −165° C. to below about −250° C.

12. The cellular glass insulation system of claim 4, wherein the cellular glass segments have a thickness of about 2 inches.

13. The cellular glass insulation system of claim 7, wherein the pipe houses liquid hydrogen, liquid nitrogen, or liquid oxygen.

14. A method of insulating a pipe, the method comprising:
providing a plurality of cellular glass insulation segments and a cryogenic coating; the cellular glass insulation segments comprising a length, an inner bore, side joint sections extending the length of the cellular glass insulation segment between the inner bore and an exterior of the cellular glass insulation segment a thickness in a radial direction, and a termination;
positioning the plurality of cellular glass insulation segments around the exterior of the pipe to form a first layer of cellular glass insulation; and
applying the cryogenic coating to the interface between the pipe and the inner bore of the first layer of cellular glass insulation segments and on the termination of the first layer of cellular glass insulation and along an interface formed between the inner bore and the exterior of the pipe.

15. The method of claim 14 further comprising positioning additional cellular glass insulation segments around the first layer of cellular glass insulation to form a second layer of cellular glass insulation.

16. The method of claim 14, wherein the cryogenic coating is applied to the exterior of the pipe in an amount sufficient to fill the space between the pipe and the inner pipe bore(s).

17. The method of claim 15 further comprising applying the cryogenic coating to the termination of the second layer of cellular glass insulation and along an interface formed between the inner bore of the second layer of cellular glass insulation and the exterior surface of the inner layer of cellular glass insulation.

18. The method of claim 15 comprising applying the cryogenic coating to the entire circumference of the interface.

19. The method of claim 15, wherein the cryogenic coating is applied to a thickness of about 1 mm to about 3 mm.

20. The method of claim 15, wherein the pipe operates at a temperature of below about −165° C.
